(19) United States
(12) Patent Application Publication
(10) Pub. No.: US 2013/0089733 A1
(43) Pub. Date: Apr. 11, 2013

(54) STRUCTURAL PANELS STIFFENED BY MAGNETICALLY-ASSISTED APPLICATION OF THICK POLYMER COATINGS

(71) Applicants: Rajesh Raghavan, Bangalore (IN); Bhaskar Patham, Bangalore (IN); Shivaram Ac, Bangalore (IN); Arun M. Kumar, Bangalore (IN); Hesham A. Ezzat, Troy, MI (US); Prakash D. Mangalgiri, Bangalore (IN)

(72) Inventors: Rajesh Raghavan, Bangalore (IN); Bhaskar Patham, Bangalore (IN); Shivaram Ac, Bangalore (IN); Arun M. Kumar, Bangalore (IN); Hesham A. Ezzat, Troy, MI (US); Prakash D. Mangalgiri, Bangalore (IN)

(73) Assignee: GM GLOBAL TECHNOLOGY OPERATIONS LLC, DETROIT, MI (US)

(21) Appl. No.: 13/267,047

(22) Filed: Oct. 6, 2011

(51) Int. Cl. B32B 27/18; B05D 7/00; B05D 3/00; B05D 5/00

(52) U.S. Cl. 428/339; 427/598

(57) ABSTRACT

The geometric stiffness of structural sheet metal panels, such as those employed in motor vehicles, may be increased, without major increase in the mass of the panel, by application of a coating of a structural polymer. However conventional means of applying such a polymer layer require multiple applications to achieve a desired thickness. By incorporating magnetic particles in a resin, and subjecting the resin to a magnetic field as it is applied, the desired thickness may be achieved in a single application. Embodiments appropriate to the application of such a resin to both magnetic and non-magnetic materials are described.

### TECHNICAL FIELD

This invention pertains to thin, light-weight structural panels stiffened by the magnetically-assisted application of relatively thick polymer coatings. Magnetizable particles are dispersed in a liquid thermosetting prepolymer composition and one or more magnetic fields are used to deposit a single layer of increased viscosity, curable polymer coating material in a predetermined stiffening thickness pattern on predetermined surfaces of a suitably shaped structural panel member. In preferred embodiments, the practice is used, for example, to selectively stiffen thin, high strength steel alloy sheet members for automotive vehicle structures to satisfy vibration or noise requirements, or like structural requirements.

### BACKGROUND OF THE INVENTION

The bodies of motor vehicles must satisfy numerous requirements, to meet customer expectations and regulatory requirements, including managing the loads to which the body is subjected and minimizing the transmission of road and engine noise and vibration to vehicle occupants. A body is usually assembled from a number of simple structural elements which may include generally planar sheets, or “C”- or “U”-shaped sections. Often such “C”- and “U”-shaped members are ‘closed out’ by addition of another element to form a combination element with a closed or “box” section.

In seeking to reduce vehicle mass and improve fuel economy, motor vehicle manufacturers continue to substitute thinner-gage sheet steels or lighter-weight materials, such as aluminum, magnesium and polymer composites in vehicle structures. Downgaging of steel sheets is enabled by the development of advanced high strength steels that provide higher strength to weight ratios. Less dense materials such as aluminum or magnesium alloys may be of comparable thickness but such materials exhibit a lower elastic modulus than steel; low-density polymer panels, often reinforced with glass or carbon fiber, also exhibit a lower elastic modulus than steel.

Such materials may be selected and applied to achieve a suitable strength if the body deforms homogeneously. But the substitution of such thinner gage or lower elastic modulus materials may render such vehicle bodies more prone to unacceptable deflection and/or vibration, resulting in the perception of lower stiffness or more properly, flexural rigidity which is defined as the product of elastic modulus and moment of inertia. Also, such thinner gage bodies may be less effective in damping or suppressing noise and vibration.

There is therefore a need for materials which, when formed and assembled into a vehicle body, enable mass reduction without loss of noise and vibration management functionality, and with high perceived flexural rigidity.

### SUMMARY OF THE INVENTION

Certain high strength steel alloys, including, but not limited to, DP 1000, a Dual Phase Steel exhibiting a Tensile Strength of 1000 MPa, after hot and cold rolling to sheet thicknesses of, for example, about 0.5 mm (500 micrometers), are found to have suitable tensile strength values for many automotive vehicle structural panel applications. And body structures of such reduced thickness would provide weight reduction in the vehicle for improved fuel economy. But in many vehicle structure applications the narrow thickness of the steel member may result in unacceptable structural deflections. In accordance with embodiments of this invention, the shape of the potential reduced thickness steel member is analyzed to determine if the perceived flexural rigidity of such steel member may be suitably improved with an applied coating thickness of a thermoset polymer precursor composition, such as an epoxy-based polymer material. Such a coating would be evaluated for application over the entire surface of one or both sides of the formed or un-formed steel sheet material, or in predetermined selected surface regions of the sheet material. It is understood that such stiffening polymer coatings, having thicknesses in significant proportion to the thickness of the steel member, could be applied without increasing the weight of the coated steel member as much as by using a heavier grade of the steel material. Of course, such polymer coating stiffening-potential could be considered when using thin sheets of other metal alloys, such as suitable aluminum and magnesium alloys. And the polymer coating stiffening-potential could be considered on thin nonmetallic workpieces, but, often, with less advantage to increasing the thickness of the original part.

The thickness of the coating deposited in a single application will depend upon the viscosity of the coating since excess coating precursor will not be retained on the part but will simply flow or drip freely off the part. Thus a suitable coating thickness may require multiple applications of coating precursor, and intervening curing steps to progressively build the coating thickness to a suitable extent.

In a practice of this invention suited to magnetizable substrates such as steels, magnetizable particles, such as pure iron particles, are dispersed in a substantially solvent-free mixture of precursor materials for a thermosetting resin. A magnetic field applied to the magnetizable substrate that is to be coated with the polymerizable mixture. The particles dispersed in the polymerizable mixture increase the viscosity of the mixture, and any magnetic field acting on the dispersed particles magnetizes them to further increase the viscosity of the coating material. It is preferred that such magnetic viscosity enhancement occur at or near the substrate surface to enable a less flowable and more drip-resistant coating so that a thicker coating may be applied to the substrate, and at least fewer coating applications are required to achieve a suitable overall coating thickness. The surface or surfaces of the thin workpiece to be stiffened are brought into contact with the dispersed particle-containing, polymer precursor material and the magnetic field is established so as to direct the polymer material against surfaces of the workpiece coating them with a magnetically-induced, desirably thick coating layer of the viscous, uncured material. The workpiece is removed from contact with the coating material while still under the influence of the magnetic field. The polymerization of the reacting precursors is completed using any suitable polymerization reaction-inducing energy producing means. After curing of the polymer coating matrix, the dispersed particles are demagnetized, as well as the workpiece if it was magnetized by the applied magnetic field.

A reinforced polymer coating thickness of 400 micrometers is readily obtained with addition of only 5% by weight of iron particles (or other suitable ferromagnetic particles. This thickness is sufficient to appreciably increase the flexural stiffness of a 500-650 micrometer thick high strength steel panel or of an 800-1000 micrometer high strength aluminum or magnesium alloy panel.

The liquid polymer precursor material may include an initiator or catalyst to promote curing subsequent to application as well as a suitable surface agent or surfactant for improving the dispersion of the particles with the polymer precursor. Suitable thermoset resin chemistries include, but are not restricted to, epoxy-amine resins, epoxy-isocyanates, epoxy-polyester resins, vinyl-ester resins, and polyurethane resins. The magnetizable particles may be of any convenient shape, generally spherical, acicular or needle-like, or flake-like to achieve the desired thickness of polymer coating in the applied magnetic field. As stated, the particles increase the viscosity of the precursor polymer materials and, when exposed to a predetermined magnetic field, the particles induce the flow of the resin to desired surface regions of the workpiece.

The coating may be applied to any of, both sides of a panel or other workpiece, only one side of a panel or selected regions of one or both sides of a panel. Application may be by dipping in a bath or spraying or other convenient method. The method may, in different embodiments, be adapted to ferromagnetic steel panels or to non-magnetic aluminum alloy, magnesium alloy and polymer panels.

As stated, by incorporating initially un-magnetized ferromagnetic particles into the resin, in suitable concentration, the primary benefit is that the particle-containing resin, if subjected to a magnetic field, will exhibit a magnetorheological-driven graded viscosity governed by the field. The cooperative interaction between the external magnetic field and the ferromagnetic particles in developing a higher viscosity in predetermined locations and adjacent to the workpiece surface that is to be coated may enable application of an appreciably thicker resin layer in a single operation. Once cured, the magnetic particles may serve as reinforcements, enhancing both the strength and elastic modulus of the coating as well as creating polymer-particle interfaces for enhanced damping of noise and vibration.

The interaction between the particles and the magnetic field may, because of the induced higher viscosity, result in a gradually increasing resin layer with time. Thus, development of a preferred coating thickness may require that the panel remain exposed to the resin for a pre-determined period of time.

Magnetically soft materials are preferred since, in general it is preferred that the panel, once formed, be substantially non-magnetic. The materials, as incorporated into the resin, should not be magnetized so that they may remain substantially dispersed in the resin without clumping or otherwise aggregating. Suitable magnetic materials may include metals such as iron, suitably carbonyl iron powder, nickel or cobalt or the soft ferrites, for example, manganese-zinc ferrite, Mnₐ Zn₍₁₋ₐ₎Fe₂O₄ or nickel-zinc ferrite, Niₐ Zn₍₁₋ₐ₎Fe₂O₄ or iron oxide Fe₂O₃.

Concentrations of magnetic material of between 1 and 25 percent by mass or between about 0.2 and 7 percent by volume may be effective in building coating layers of suitable thickness. The magnetic particles should be generally uniformly dispersed in the resin and may range in size from about 1 to 500 micrometers in longest dimension. Those particles of more compact, generally spherical, morphology may range from about 1 to 50 micrometers while more acicular or more flake-like particles may range from about 10 to 500 micrometers in longest dimension.

A thick coating is desirable since the stiffness-enhancing character of the coating varies with its thickness, so, a thicker layer will be more effective. Similarly the damping characteristics of the polymer layer resulting from curing of the resin will be improved by addition of more material. In addition, the plurality of resin-particle interfaces resulting from the incorporated particles may further enhance the damping characteristics of the coating. Because of their large surface to volume ratio, flake-like particles may be most effective in enhancing damping.

Magnetic structural materials, such as steels, may be magnetized by exposure to an external magnetic field using an electromagnet or by passage of an electric current. After removal of the magnetic field or current, some remnant magnetism will remain, which, on exposure to a resin charged with ferromagnetic particles, may increase its viscosity locally through magnetorheological effect and enable deposition of a thicker coating than would be achieved with resin alone. If a sheet metal structural element were so magnetized, a flowable resin-hardener-magnetic particle blend or slurry may be applied to one surface of a structural element by spraying or otherwise coating only that surface or to both surfaces by dipping or spraying or other convenient method. If selective magnetization is desired, the current density in different regions of the element may be varied appropriately or a magnetic field may be applied to only select parts of the element. Such selective application of coating may be required if the element is to be assembled by welding, for example electric resistance spot welding.

The resin may then be cured to form, on the structural element, a magnetic particle-reinforced, polymer layer. It will be appreciated that, if cured by heating, the viscosity of the resin will first decrease as it is heated above ambient temperature before increasing again as cross-linking proceeds. During this low viscosity transient state, the resin, even in the presence of the magnetized structural element, may flow to produce a thinner layer than was first applied. This thinning may be counteracted by applying a supplementary current or an external magnetic field during curing. But thermal thinning is most readily dealt with by avoiding any necessity for thermal curing by using a resin-hardener system suitable for ambient temperature cure or by using a non-thermal cure process such as an electron beam or ultraviolet (UV) light with appropriate additions of initiator to the resin if required.

Non-magnetic materials may also be coated by positioning groups of magnets, permanent magnets or electromagnets, on one side of the sheet-based reinforcing element in regions where a coating is desired and applying the resin on the opposing side. One preferred approach is to magnetize a steel panel and sandwich the magnetized steel sheet between two non-magnetic panels. The three-layer sandwich may then be dipped into a magnetic particle containing resin bath where the remnant magnetism of the steel sheet will promote resin deposit of suitable thickness on the non-magnetic panels. Once the resin is deposited it may be cured, as before, to develop the desired thick coating comprised of the magnetic particle-containing polymer-composite.

Arrays of electromagnets or permanent magnets in face-to-face contact with a non-magnetic panel may also be employed as sources of a suitable magnetic field for resin deposition. In this approach the thickness of the resin will depend on the placement of the magnets, being generally thicker directly over a magnetic pole and thinner elsewhere. The behavior of the coating when two or more magnetic poles are placed adjacent to one another will depend on their relative polarity.

All of the approaches for non-magnetic panels, in contrast to the method for magnetic panels, produce a panel with polymer reinforcement on one side only. This, depending on the coating thickness, may be adequate. If a two-sided coating is desired, the process must be repeated with the panel reversed to present its uncoated side to the resin.

Other objects and advantages of the invention will be apparent from a detailed description of various embodiments of the invention.

### BRIEF DESCRIPTION OF THE DRAWINGS

FIG. 1 is a schematic illustration of how at least a portion of a steel body panel may be magnetized by exposure to a magnetic field generated by an electromagnet.

FIG. 2 graphically illustrates a representative relationship between the intensity of an applied magnetic field and the magnitude of the induced magnetic flux density for a steel like that of the body panel of FIG. 1. The varying field and resulting varying induced flux density is superimposed on the graph to illustrate the variation of induced magnetic flux density in the panel as it is brought into the magnetic field and then removed from the magnetic field, and particularly, how a remnant flux density may remain even after the panel is completely removed from the field.

FIGS. 3A-3C is a series of Figures illustrating the accumulation of magnetic particle-containing resin on the magnetized portion of a ferromagnetic panel magnetized over only a portion of its extent when immersed in a bath of polymer resin containing demagnetized ferromagnetic particles.

FIG. 4 illustrates the curing of the partially-magnetized panel with resin coating shown in FIG. 3C.

FIG. 5 Illustrates the demagnetization of the partially-magnetized panel to render it substantially demagnetized.

FIG. 6 graphically illustrates a representative relationship between the intensity of an applied magnetic field and the magnitude of the induced magnetic flux density for a steel like that of the body panel of FIG. 1. The Figure demonstrates how demagnetization of the panel may result from application of a magnetic field which is the reverse of the initially-applied field.

FIG. 7 illustrates how a plurality of electromagnets may be positioned in frame to form a selectively magnetizable magnetic array.

FIGS. 8A-F illustrate a sequence of steps for applying a patterned magnetic particle-containing polymer on the surface of a non-magnetic panel using the selectively magnetizable magnetic array and a ferromagnetic panel.

FIG. 9 shows a permanent magnet array suitable for applying a magnetic particle-containing polymer on the surface of a non-magnetic panel.

### DESCRIPTION OF PREFERRED EMBODIMENTS

The bodies of motor vehicles must manage the loads applied both during normal vehicle service and under extraordinary conditions such as a collision. Increasingly, vehicle bodies are constructed using materials such as high strength steel, aluminum alloys, magnesium alloys and polymer-based composites, all of which offer higher strength to weight ratios than the low strength, low carbon steel used in older vehicles and enable mass reduction. Such materials are sized and selected to ensure that plastic or permanent deformation does not occur in normal use and that under abnormal operating conditions, such as a collision, deformation occurs in a predictable and controlled manner.

But, such strength-perfected designs may be stiffness limited. The two most important properties relating to the stiffness of a structure are the elastic modulus of the material and the moment of inertia of the structure, also known as material stiffness and geometric stiffness, respectively. Reductions in panel thickness may reduce the perceived geometric stiffness and substitution of lower modulus aluminum and magnesium alloys or polymer-based composites for steel involve substitution of conventional steel with lower stiffness materials. Hence any mass-reduction strategy must be tailored to retain the body stiffness as contributed by the material and the part geometry, including its gage.

An approach to increasing the body stiffness is to increase the flexural rigidity or geometric stiffness of structural panels by: applying a polymer precursor to at least a portion of a surface of such a panel; and curing the precursor to form a polymer coating on the panel surface; and repeating the process as required to develop a suitable coating thickness.

In this invention, a magnetic particle reinforced polymer resin blend or precursor, optionally incorporating surfactants, initiators and/or catalysts, may be deposited, in the presence of a magnetic field, on a structural panel. The thickness of the deposit may increase over time requiring that the panel and resin remain in contact for some pre-determined period of time and that the magnetic field continue to be applied during this time. The introduction of the magnetic particles and the interaction of the magnetic particles with the magnetic field, will increase the viscosity of the resin blend-magnetic particle mixture relative to the resin blend alone. And, as a consequence of the increased viscosity a greater thickness of the magnetic particle-reinforced resin may be deposited in a single application.

The deposit may then be cured, forming a particle-reinforced polymer composite of sufficient thickness to increase the moment of inertia of the panel and hence its geometric stiffness. Even modest concentrations of magnetic particles, say 5% by weight or about 1% by volume, may, in the presence of readily-achievable magnetic fields, enable polymer layer thicknesses of 200 micrometers. Such a polymer layer thickness is readily capable of imparting enhanced geometric stiffness and noise and vibration damping to a high strength steel panel with a thickness of between 500 and 650 micrometers or to a high strength aluminum or magnesium alloy panel of 800 to 1000 micrometers in thickness.

In many applications it may be preferred to deposit a continuous layer of near-uniform thickness on both panel surfaces, but in other situations, a deposit of varying thickness on one or both panel surfaces may be adequate. In yet other applications it may be preferred to deposit resin as one or more discrete stiffening ribs or ridges in only the most highly flexed regions of the panel and leave the remainder of the panel uncoated.

The addition of the magnetic particle reinforcements which may be of any suitable geometric form including generally spherical, acicular or flake-like increases the viscosity of the resin blend. Also the particle reinforcements are intended to be ferromagnetic so that, in interacting with an imposed magnetic field, they will yet further increase the viscosity of the resin. Hence the magnetic field and the magnetic particles cooperate to deposit a thick, adherent resin layer on the surface. Because of this higher viscosity, a thicker resin layer may be deposited in a single application. And by maintaining the magnetic field during curing, the resulting polymer layer will retain the thickness of the resin deposit. Preferably curing occurs at room temperature to avoid any thermally-driven viscosity reduction, and thinning of the resin layer, during curing, but alternatively, the magnetic field may be tuned to offset the viscosity reduction by a suitable extent during high-temperature cure. Once cured and polymerized, the magnetic field may be removed.

The magnetic particles should be ferromagnetic, but, as blended with the resin, should be substantially demagnetized to minimize clumping or aggregation of the particles and achieve a generally uniform particle dispersion in the resin. Any of the classes of ferromagnetic materials may be used, including: metals such as iron, nickel or cobalt; alloys and compounds such as those based on neodymium and iron and samarium and cobalt as well as Alnico; and oxides including iron oxide, Fe₂O₃ and ferrites. Where it may be required to minimize any remnant magnetism, magnetically soft materials, such as substantially pure iron, iron oxide, Fe₂O₃ and soft ferrites such as, for example, manganese-zinc ferrite, MnₐZn₍₁₋ₐ₎Fe₂O₄ or nickel-zinc ferrite, NiₐZn₍₁₋ₐ₎Fe₂O₄ may be employed. Particles of several such magnetically soft materials may be employed in combination.

While a sufficient thickness of polymer should be applied to increase the geometric stiffness of the panel or structure, the added thickness should not be such as to negate the mass reduction which initially prompted the addition of the stiffening layer. In this regard the low specific gravity of the polymer, ranging from about 1.1 to about 1.4, lower even than that of magnesium, is beneficial. However the density advantage enjoyed by the polymer will be offset by the higher specific gravity of the magnetic material which may range from about 5 for ferrites to about 7 for iron.

Pulverized iron particles or flakes may be preferred. Such plate-like particles may be formed by ball milling substantially spherical iron particles dispersed in a fluid to prevent welding of the particles to one another. At a specified volume fraction, such flake-like particles may be more effective in increasing the modulus of the resulting polymer-magnetic particle coating and enhancing the stiffness of the coating as well as the geometric stiffness of the substrate. Also the large surface area of such flake-like particles enables a large polymer-particle interface which may be effective in damping noise and vibration.

In a first embodiment, applicable to ferromagnetic structural panels fabricated, for example, of high strength steel, the panel itself or, more commonly, a portion of the panel may first be magnetized, either by passage of electric current through the panel or by exposure to a magnetic field. It will be appreciated that vehicle bodies are often joined using resistance spot welding so that having some portion of the panel remain uncoated by polymer, and electrically conductive, may be required to facilitate subsequent assembly and joining of panels. If mechanical joining methods such as clinching or riveting are contemplated however, complete coverage of the panel may be acceptable.

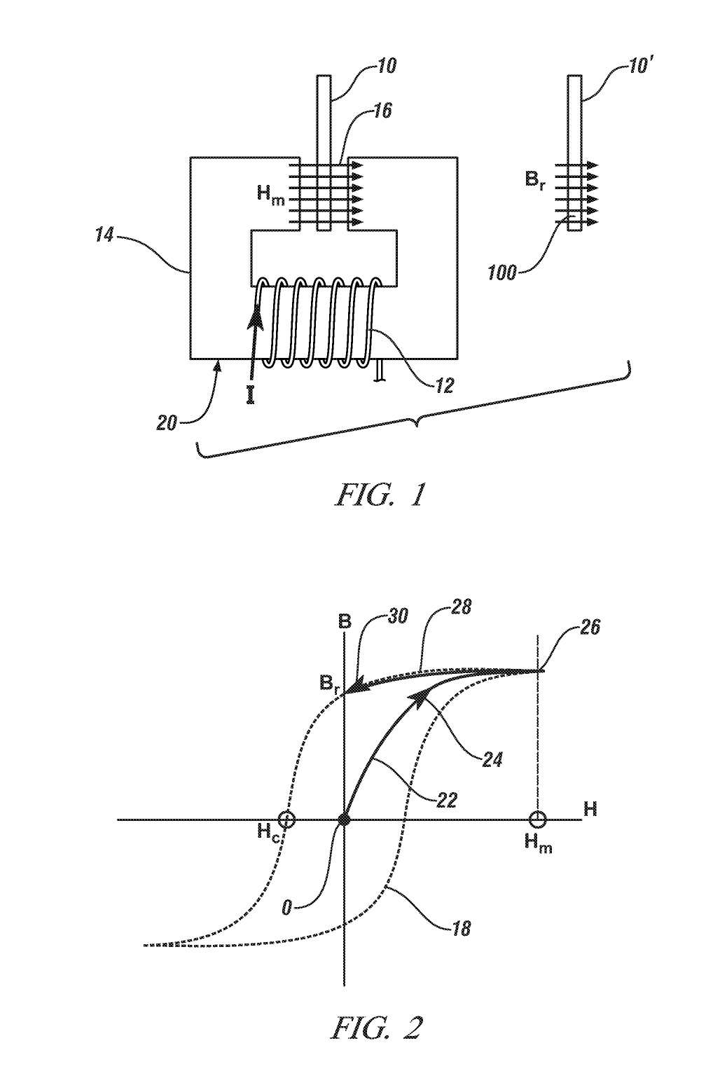

As shown in FIG. 1, a magnetic field Hₘ may be developed in the gap 16 of a magnetic core 14 excited by passage of a current I through coil 12. Passage of a steel panel 10 with the magnetization loop 18 shown in FIG. 2 though gap 16 will expose at least a portion of panel 10 to a magnetic field H which will progressively increase to Hₘ. This corresponds to a path 22, originating at the origin O and directed as indicated by arrowhead 24 in FIG. 2. As the field experienced by panel 10 increases to Hₘ, a similar increase occurs in the magnetic flux density B induced in panel 10. As the panel 10 is withdrawn from gap 16, the field H will progressively decrease to zero. As it does so, the magnetic flux density in panel 10 will follow path 28 in the direction of arrowhead 30 (FIG. 2), so that when H is zero the panel 10′ will display some remnant flux density Bᵣ in the exposed region 100 as shown in FIG. 1.

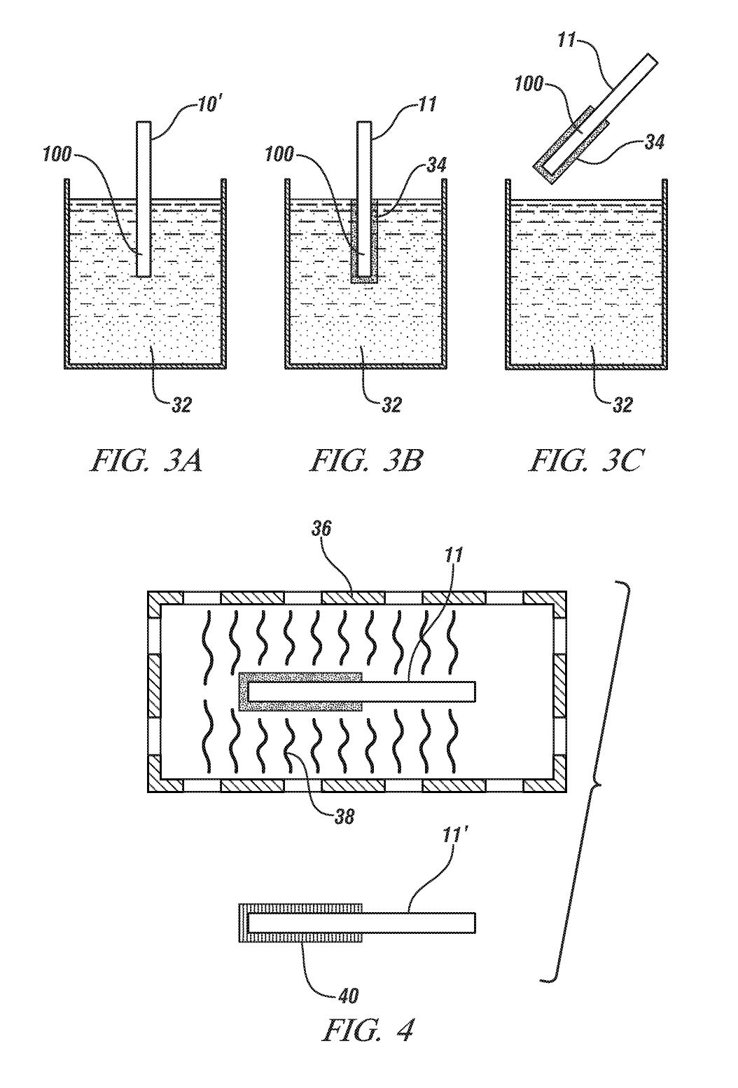

After the panel is magnetized, in whole or part, it may be coated with polymer resin into which magnetic particles have been incorporated. A procedure is shown in FIGS. 3A-3C. Magnetized panel 10′ is immersed in a bath of magnetic particle-containing resin 32 (FIG. 3A) for a time sufficient to enable interaction between the magnetic particles and magnetized portion 100 to attract a layer of resin, and its associated particles, 34 to the magnetized portion 100 of the panel 11 (FIG. 3B). Layer 34 remains attached to magnetized portion 100 after removal from the bath (FIG. 3C).

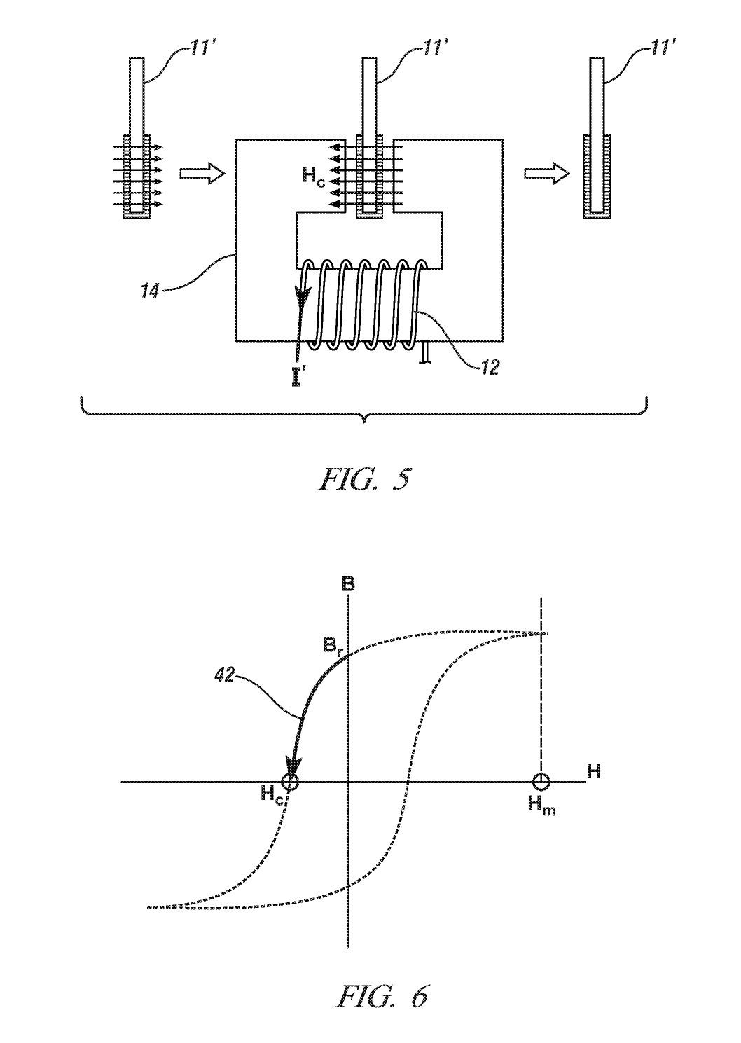

The magnetic particle-containing resin 34 deposited on and attached to the coated panel 11 may then be cured, either at ambient temperature or at elevated temperature or by radiation 38, for example in chamber 36 (FIG. 4). At the conclusion of the curing process, panel 11′, which has deposited on a portion of its surface an adherent polymer layer incorporating magnetic particles 40, may be removed and assembled into a vehicle body structure. As shown in FIG. 5, The coated panel 11′ may then be demagnetized by application of a reversed magnetic field of strength applied by coil 12 and magnetic core 14 by application of a current I′ directed opposite magnetizing current I (FIG. 1). Such a procedure will generally correspond to path 42 shown in FIG. 6 which, as shown results in the reduction of the magnetic flux density to substantially zero.

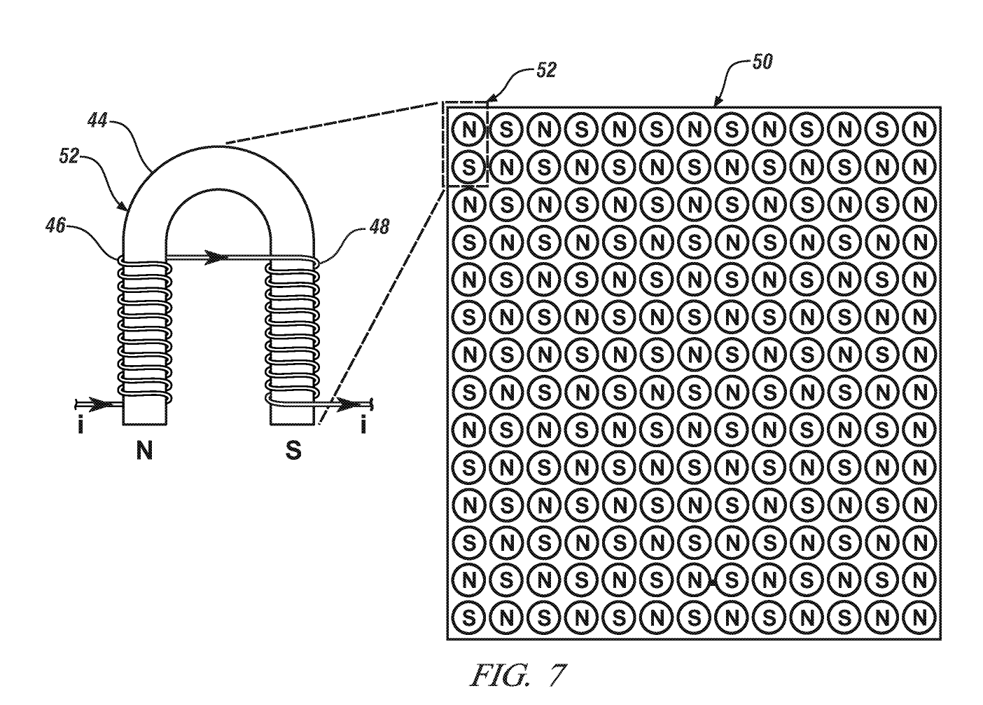

An alternative approach to magnetizing large panels is shown in FIG. 7 in which a plurality of U-shaped electromagnets 52 are arranged and grouped in a frame 50 to produce an aggregated magnetic field which covers an area substantially equal to that of frame 50. Each of the electromagnets 52 consists of a U-shaped soft magnetic structure 44 which supports electrically connected coils 46 and 48. Under passage of an electrical current i, one leg of the “U” will be the north pole of the electromagnet while the other leg will be the south pole. By arranging and appropriately securing a plurality of such electromagnets within a frame 50, a magnetizing plate or table suitable for simultaneously magnetizing an extended area may be produced. The arrangement and number of electromagnets shown is merely illustrative of one of many possible configurations of the individual electromagnets 52 and is not intended to be limiting.

In operation, a common current may be passed through each of the plurality of electromagnets shown in FIG. 7 or a range of currents, including zero current, may be passed through each electromagnet. That is, the electromagnets may be operated to produce a generally uniform magnetic field over substantially the entire area of frame 50 or to produce a spatially varying field across frame 50. Of course, a similar arrangement of permanent magnets may be employed if only a single magnetic field pattern is required and the programmability and flexibility afforded by an independently controllable array of electromagnets is not required.

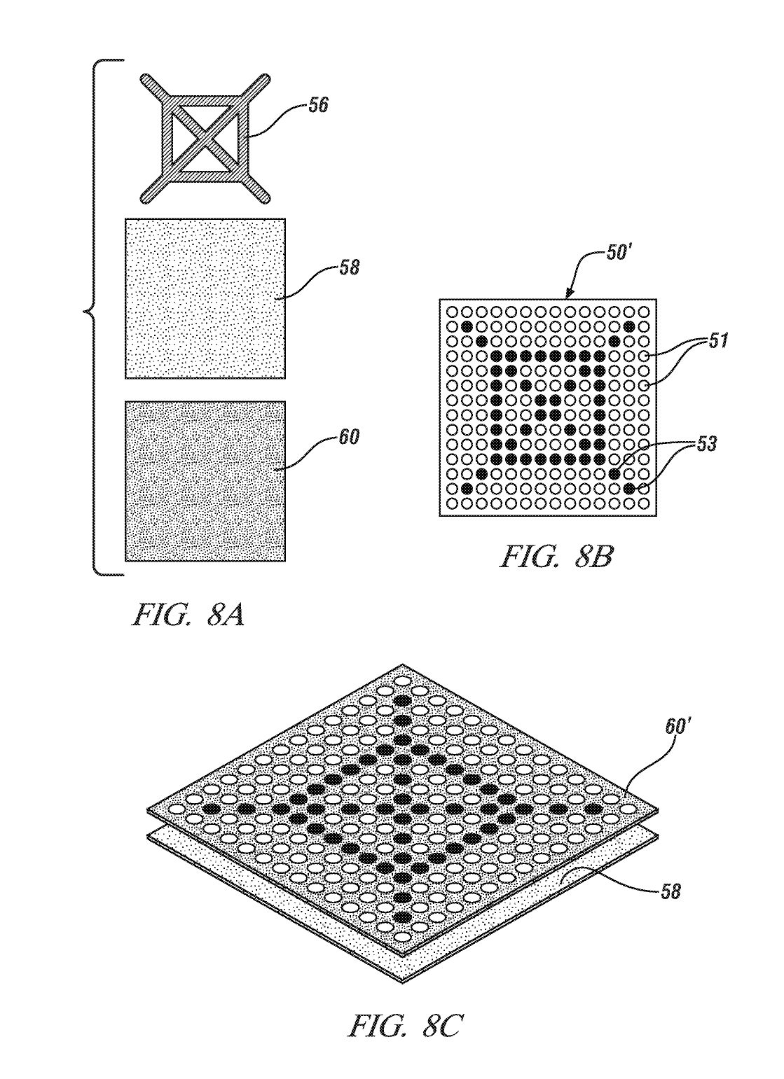

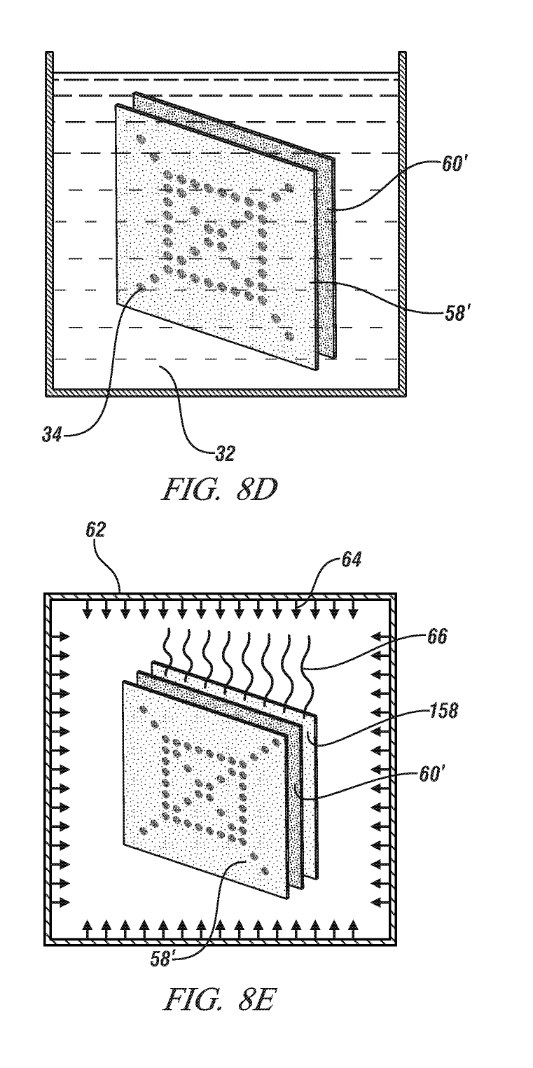

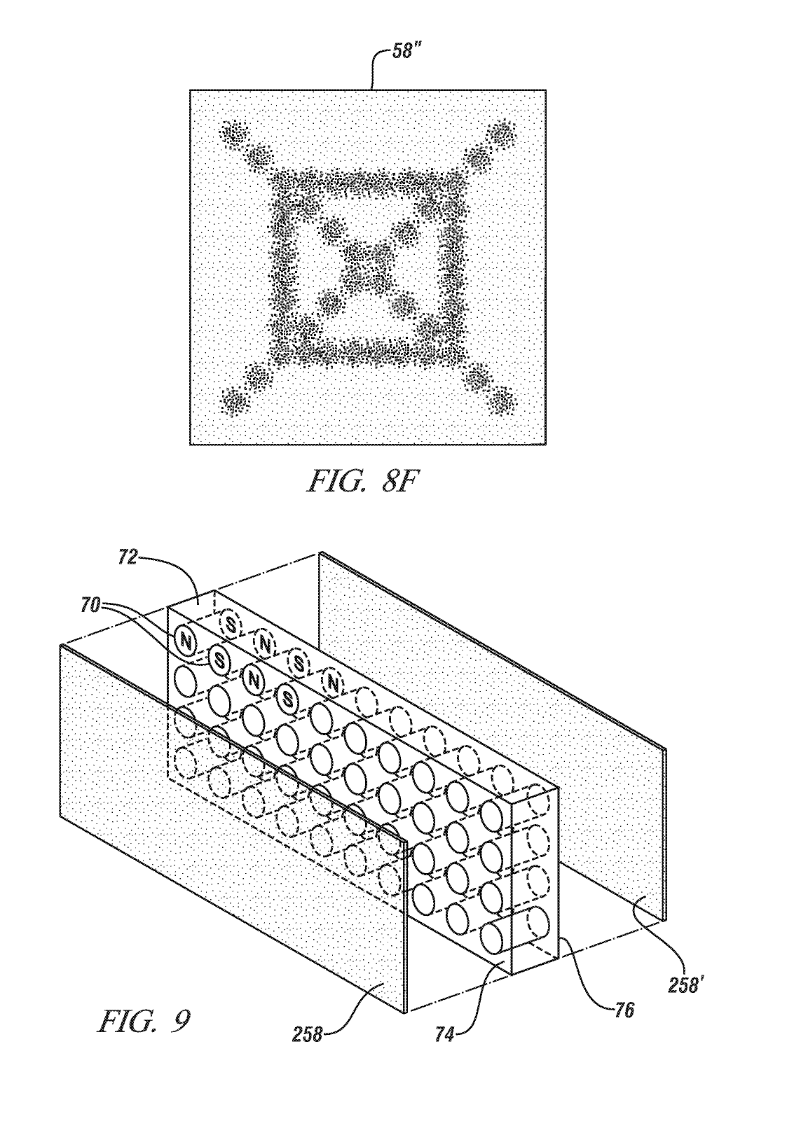

For non-magnetic panels, such as those fabricated of aluminum or magnesium alloy or of polymer composites, a different practice may be followed, best illustrated in FIGS. 8A through 8F. It is desired to apply polymer in pattern 56 (FIG. 8A) to non-magnetic panel 58. Ferromagnetic panel 60 may be employed as a templating device. FIG. 8B shows the electromagnetic array 50′ analogous to that shown in FIG. 7 with active magnetic elements 53 and inactive magnetic elements 51 where the active magnetic elements map out a discretized representation of the desired pattern 56. Ferromagnetic panel 60, when placed on and in contact with electromagnetic array 50′ will develop magnetized regions corresponding to the magnetically active elements 53 shown in FIG. 8B. Now-magnetized ferromagnetic panel 60′ is placed with one face in face-to-face contact with non-magnetic panel and 58 (FIG. 8C) and the two panels, still in face-to-face contact placed in a bath of magnetic particle-containing resin 32 (FIG. 8D). The magnetic fields of magnetized ferromagnetic panel 60′ will attract the magnetic particles and lead to a build-up of discrete resin layer patches 34 and their associated particles on the surface of non-magnetic panel 58′ (best seen in FIG. 8F). It will be appreciated that as depicted in FIG. 8D, the magnetized panel 60′, on being exposed to magnetic particle-containing resin 32 will similarly attract resin layer patches which will need to be removed. A better practice, illustrated during the step of curing the resin at FIG. 8E is to place magnetized panel 60′ in face-to-face contact with, and sandwiched between, two nonmagnetic panels 58′, 158. With appropriate attention to excluding penetration of particle-containing resin 32 between the faying surface of 60′ and 58′ and 158 respectively, magnetized panel 60′ may be recovered and re-used at the conclusion of the process.

As shown in FIG. 8E the magnetized 60′and n on-magnetic panel(s) 58′, 158 must remain in contact during curing to avoid any reduction in viscosity on removal of the magnetic field and possible thinning of the resin. Curing of the resin to form a polymer will normally take place in a container or vessel 62 using heat 64 or radiation 66 as described previously. For the reasons detailed previously and to maintain the greatest resin and polymer layer thickness, radiation curing is preferred.

The resulting non-magnetic panel, with its applied magnetic particle reinforced polymer pattern 58″ is shown at FIG. 8F. It may be noted that because of the reduction in field intensity with distance from the magnetic pole, the applied polymer pattern is ‘fuzzier’ than the pattern shown on magnetic frame 50′ or magnetized panel 60′, reflecting the gradual change in polymer thickness with distance from the pole.

If multiple similar parts are to be processed, magnetized panel 60′ may be re-used and returned to the stage in the process (shown at FIG. 8C) where it is assembled to the non-magnetic panels. If a double-sided coating is desired, panels 58″ and 158 may also be returned and re-united with magnetized panel 60′ before dipping and curing to develop the requisite coating on their uncoated surface.

When a new pattern is required, magnetized panel 60′ may be demagnetized as previously described and then re-enter the process as ferromagnetic panel 60 at FIG. 8A.

Greater layer thickness may be achieved by applying a higher intensity magnetic field such as by applying the generated magnetic field of magnetic frame 50 directly to the non-magnetic panel. This would require placing a face of non-magnetic panel 58, oriented horizontally, in direct contact with the magnetic poles of magnetic frame 50′. A dip process would be challenging and it would be more suitable to apply magnetic particle-containing resin using a spray or roller. However, since the panel is required to remain under the influence of the magnetic field during cure the productivity of such a procedure will be less than is achievable through using a readily-replicated, low cost, magnetized panel to apply the magnetic field.

Replacing the electromagnetic array with permanent magnets would also enable processing of two non-magnetic panels simultaneously and facilitate dipping. A suitable arrangement is shown at FIG. 9. A series of permanent magnets 70, preferably high performance rare earth magnets such as samarium-cobalt based or neodymium-iron based compositions, here shown as arranged with alternating north and south poles is secured within a continuous, liquid-excluding mounting block 72 with substantially flat, outward-facing, near parallel faces 74, 76. The magnetic field distribution is thus comparable on each of faces 74 and 76 so that non-magnetic panels may be secured in face to face relationship with faces 74 and 76 and the entire assembly dipped in magnetic particle-containing resin to achieve the qualitative results described previously but at greater polymer patch thickness.

Mounting block 72 may be a polymer or a non-magnetic metal such as copper, brass or bronze among others. Block 72 may be reuseable and fabricated with an array of openings each sized to accept and retain a magnet so that any desired magnet array may be developed by selectively placing magnets in some locations but not others. Alternatively block 72 may be uniquely designed for each magnet array, for example by casting a polymer support block around pre-positioned magnets.

In an exemplary practice, two-part, room-temperature-curing, epoxy-amine resin was prepared containing dispersed, generally spherical, 10 micrometer diameter iron particles in a mass fraction of about 5%. Two thin, mild steel sheets, 0.8 millimeters thick, one magnetized at one end using a permanent magnet and the other un-magnetized, were placed in the bath for a few (1 to 10) seconds to develop a resin coating and then withdrawn. On curing the resin coating the thickness of the polymer layer on the magnetized sample was about 400 micrometers or about 24% thicker than the polymer coating on the unmagnetized sample.

Practices of the invention have been described using certain illustrative examples, but the scope of the invention is not limited to such illustrative examples.

1. A method of increasing the flexural rigidity of a sheet material workpiece for use in a vehicle body structure by coating the workpiece with a single layer of a predetermined thermoset polymer composition to a predetermined thickness and thereby increasing the geometrical stiffness of the workpiece, the method comprising:
identifying a surface of the sheet material workpiece for increased geometrical stiffness, and determining a suitable thickness of the thermoset polymer composition for increased geometrical stiffness of the sheet material workpiece;
preparing a volume of liquid precursor of the thermoset polymer composition for the coating of identified surfaces of one or more of the sheet material workpieces, the liquid precursor containing a dispersed quantity of un-magnetized ferromagnetic particles;
using one or more magnetic fields to direct liquid precursor into contact with the identified surface of each sheet material workpiece and to coat the identified surface with the ferromagnetic particle-containing liquid precursor, the magnetic field magnetizing the ferromagnetic particles and increasing the viscosity of the liquid precursor in the coating of the identified surface;
removing the sheet material workpiece from contact with the liquid precursor while maintaining the magnetic field on the workpiece surface;
promoting curing of the ferromagnetic particle-containing liquid precursor to form the single stiffening layer of the thermoset polymer on the identified surface; and
demagnetizing the ferromagnetic particles dispersed in the stiffening layer of thermoset polymer and, if necessary, demagnetizing the workpiece.

2. The method of claim 1 in which the sheet material workpiece is formed of a ferromagnetic metal alloy and the magnetic field that is used is obtained by selective magnetization of the ferromagnetic alloy workpiece.

3. The method of claim 1 in which the sheet material workpiece is formed of a non-magnetic material and the magnetic field that is used is provided by a magnetized body placed adjacent to the sheet metal workpiece.

4. The method of claim 1 in which the un-magnetized ferromagnetic particles are present in an amount ranging from 1 percent to 25 percent by weight and comprise at least one magnetically soft magnetic material.

5. The method of claim 4 in which the un-magnetized ferromagnetic particles are shaped as one or more of the group consisting of substantially spherical, acicular and flake-like.

6. The method of claim 5 in which the length of the longest particle dimension ranges from 1 to 500 micrometers.

7. The method of claim 4 in which the soft magnetic materials are one or more of the group consisting of substantially pure iron, iron oxide, Fe₂O₃, carbonyl iron powder, manganese-zinc ferrite, MnₐZn₍₁₋ₐ₎Fe₂O₄ and nickel-zinc ferrite, NiₐZn₍₁₋ₐ₎Fe₂O₄.

8. The method of claim 1 in which curing of the thermosetting resin occurs at ambient temperature.

9. The method of claim 1, further comprising demagnetizing the sheet material workpiece.

10. The method of claim 3 where the magnetic body comprises a magnetized ferromagnetic sheet.

11. The method of claim 3 in which the magnetic body comprises an array of magnets.

12. A method of increasing the geometric stiffness of a ferromagnetic ferrous metal sheet material workpiece by coating with a single layer of a predetermined thermoset polymer composition to a predetermined thickness for use of the workpiece in a vehicle body structure, the method comprising:
identifying a surface of the ferrous metal sheet material workpiece for stiffening, and determining a thickness of the thermoset polymer composition for the intended geometrical stiffening of the sheet material workpiece;
preparing a volume of liquid precursor of the thermoset polymer composition for the coating of identified surfaces of one or more of the sheet material workpieces, the liquid precursor containing a dispersed quantity of un-magnetized ferromagnetic particles;
using a magnetic field to direct liquid precursor into contact with the identified surface of each sheet material workpiece and to coat the identified surface with the ferromagnetic particle-containing liquid precursor, the magnetic field magnetizing the ferromagnetic particles and increasing the viscosity of the liquid precursor in the coating of the identified surface;
removing the workpiece from contact with the liquid precursor while maintaining the magnetic field on the workpiece surface;
promoting curing of the ferromagnetic particle-containing liquid precursor to form the single stiffening layer of the thermoset polymer on the identified surface; and
demagnetizing the workpiece and the ferromagnetic particles dispersed in the stiffing layer of thermoset polymer.

13. The method of claim 12 in which the sheet material workpiece is formed of a ferromagnetic, steel metal alloy and the magnetic field that is used is obtained by selective magnetization of the steel alloy workpiece.

14. The method of claim 12 in which the sheet material workpiece is formed of a ferromagnetic, steel metal alloy having a thickness of 0.6 mm or less and the magnetic field that is used is obtained by selective magnetization of the workpiece.

15. The method of claim 12 in which the sheet material workpiece is formed of a ferromagnetic, steel metal alloy having a thickness of 0.6 mm or less, the magnetic field that is used is obtained by selective magnetization of the workpiece, and the thickness of each applied coating layer is greater than 0.1 MM.

16. The method of claim 12 where the panel is coated by immersing the panel into a magnetic particle-containing bath and the excess resin is removed by removing the panel from the bath.

17. The method of claim 12 in which the magnetic field is used to produce a variation in the thickness or the pattern of the applied stiffening layer of thermoset polymer coating.

18. A thin-gage structural panel suitable for assembly into a vehicle body, and capable of imparting strength, stiffness and sound and vibration damping to the body, the structural panel comprising a high strength to weight interior panel with two opposed surfaces and on at least a portion of one surface, a thermosetting polymer coating at least 200 micrometers thick, the thermosetting polymer comprising reinforcing ferromagnetic particles in an amount ranging from 1 to 25 percent by weight.

19. The structural panel of claim 18 wherein the interior panel is ferromagnetic.

20. The structural panel of claim 18 wherein the interior panel is non-magnetic.
